(19) United States
(12) Patent Application Publication
(10) Pub. No.: US 2005/0223589 A1
(43) Pub. Date: Oct. 13, 2005

(54) Apparatus for conditioning a tobacco product

(75) Inventors: Peter Funke, Hamburg (DE); Torsten Grigutsch, Hamburg (DE); Dietmar Zielke, Hamburg (DE); Wolfgang Denker, Hamburg (DE)

Correspondence Address: VENABLE LLP, P.O. BOX 34385, WASHINGTON, DC, 20045-9998, US

(73) Assignee: Hauni Primary GmbH, Hamburg (DE)

(21) Appl. No.: 11/099,694

(22) Filed: Apr. 6, 2005

(30) Foreign Application Priority Data
Apr. 7, 2004 (DE) 10 2004 017 596.9

(51) Int. Cl. F26B 19/00; F26B 3/08

(52) U.S. Cl. 34/360; 34/589

(57) ABSTRACT

The application relates to an apparatus for conditioning a tobacco product having a transport pipe through which a process gas flows and which has a feed section having a feed opening for feeding in the product and a following drying section, characterised in that the transport pipe has dividing means for dividing, before the feed opening, the stream of process gas into a substream picking up the product and a substream which is substantially product-free and for bringing the substreams together at the beginning of the drying section so that the product is introduced into the drying section in the inner region of the transport pipe.

### CROSS-REFERENCE TO RELATED APPLICATION

This application claims the priority of German Patent Application No. 10 2004 017 596.9 filed Apr. 7, 2004, the subject matter of which is incorporated herein by reference. The disclosure of all U.S. and foreign patents and patent applications mentioned below are also incorporated herein by reference.

### BACKGROUND OF THE INVENTION

The invention relates to an apparatus for conditioning a tobacco product having a transport pipe through which a process gas flows and which has a feed section with a feed opening for feeding the product and a following drying section.

Such conditioning apparatuses are known (DE 100 46 123 A1; EP 1 045 649 B1). In these the drying process can be adversely affected in particular by non-uniform distribution of the product over the cross-section of the drying section and possibly by clots of tobacco.

It is known to adjust the pressure in the transport pipe in the region of the tobacco inlet as a function of a measured pressure (EP 0 484 899, JP 3109044 B2).

Research Disclosure No. 434, June 2000, p. 968, discloses a pneumatic dryer having branching of the transport pipe into three conduits, wherein, depending on the mass flow rate of the tobacco, tobacco is fed into one or more conduits. The conduits merge at the end of the drying section ahead of the tobacco separator. When the mass flow rate of the tobacco to be dried is less than a maximum value the process gas not needed for drying is taken through the bypass line. In this fashion, for different mass flow rates of tobacco only the proportion of the total process gas needed at the time for drying the product is used.

An apparatus for cooling, drying or heating material in granular or powder form, in particular sand, is known from GB 907 398. The product is delivered in a lying state into the centre of the transport pipe by means of a wall projecting into the transport pipe, and is blown upwards by means of a gaseous substream flowing through two ducts, and carried by a main gas stream flowing through a further duct. Two guiding walls arranged parallel to the product delivery direction extend downstream over the feed opening into the drying section.

### SUMMARY OF THE INVENTION

The object of the present invention consists in providing a conditioning apparatus in which more uniform drying of the product in the drying section is achieved.

The invention solves this object in particular in that the transport pipe possesses dividing means for dividing, before the feed opening, the stream of process gas into a substream picking up the product and a substream which is substantially product-free and for bringing the substreams together at the beginning of the drying section so that the product is introduced into the drying section in the inner region of the transport pipe. By this means a broader distribution of the product over the cross-section of the transport pipe in the drying section and hence more uniform drying is achieved. Breaking up of clots of tobacco can be achieved at a tearing edge of the branching means at the beginning of the drying section. “In the inner region” in this case is not restricted to the central axis of the transport pipe or a narrow central region. The inner region has a spacing of at least 10%, preferably at least 20% and more preferably at least 30% of the diameter of the transport pipe from the wall of the transport pipe. The inner region may also be offset from the centre of the transport pipe. The essential feature is only that the substream picking up product is substantially not introduced into the drying section at the wall of the transport pipe.

“At the beginning of the drying section” expediently means that the dividing means extends downstream beyond the entire feed opening, preferably by at least one transport pipe diameter, further preferably by at least two transport pipe diameters. This feature is in particular advantageous with a product entering into the transport tube essentially in free fall, in order to attain an introduction of the product into the inner area of the drying section. In particular a part of the dividing means arranged perpendicular to the feed direction therefore substantially extends downstream beyond the entire feed opening.

The introduction of the substream picking up product into the drying section in the inner region of the transport pipe can be achieved in a curved transport pipe in particular by introducing the substream free of product into the drying section at the outer periphery of the curvature of the transport pipe.

In order to adjust different pressures for the substreams, the substreams are preferably substantially completely separated from one another so that gas exchange between the substreams does not take place. Preferably, an adjusting device is provided which allows the setting of the flow rate of at least one substream, preferably in particular the substream picking up product. The flow rate of the substream picking up product at the level of the feed opening is preferably set in the range of 10 to 29 m/s.

Preferably, at least one measuring device is provided for measuring the pressure or the flow rate of at least one substream. This allows in particular control or regulation of the flow rate of a substream as a function of the measured value or the measured values.

The dividing means can be achieved in simple manner by a dividing wall arranged in the transport pipe which wall starts ahead of the product feed and terminates at the beginning of the drying section. However, the invention is not restricted thereto. Also conceivable, for example, is the branching-off of a separate bypass line free of product from the transport pipe ahead of the product feed and merging the bypass line into the transport pipe at the beginning of the drying section.

In one embodiment the dividing wall is constructed for conveying a medium through the interior of the dividing wall. For this purpose, the dividing wall can be of double-walled construction for example. A cooling medium, by way of example, can be conveyed through the dividing wall in order, by way of example, at coolant temperatures of less than 100° C. to prevent deposits of tobacco due to condensed moisture on the dividing wall. For this purpose, a medium at higher temperatures by comparison with the process gas temperature can also be conveyed through the dividing wall in order to heat the dividing wall. In these cases, the dividing wall usefully has an inlet connector and an outlet connector for the medium. In a different embodiment the dividing wall comprises openings, in the form of nozzles for example, in order to convey a medium, fresh hot process gas or a conditioning medium for example, into the interior of the transport pipe.

According to another aspect of the invention the transport pipe is set up for conveying a medium through the interior of the wall of the transport pipe. For this purpose, by way of example, the wall of the transport pipe can be of double-walled construction. This aspect is based on the observation that the drying of the tobacco product by the process gas frequently occurs only in a part of the transport pipe after the inlet opening for the tobacco product, while in the adjoining part of the transport pipe the process gas is increasingly exhausted by accumulation of moisture and cooling. Accordingly, the purpose of the aspect of the invention related to this lies in improving the drying of the tobacco product. The aspect of the invention solves this task by introducing fresh, unused process gas into the interior of the transport pipe following the inlet opening for the tobacco product. Since this aspect can be viewed independently of the dividing means, claim 16 directed towards this may be independently protectable, i.e. in a form referring back only to the preamble of claim 1.

In this case the openings for introducing the medium into the interior of the transport pipe are arranged on the outside of curved transport pipe sections in order to assist the diversion of the tobacco product. Preferably, the process medium conveyed through the transport pipe wall has a higher temperature than the main stream of process gas, preferably in the range of 300 to 800° C., and preferably a higher pressure. Due to the corresponding heating of the transport pipe wall deposits of tobacco on the transport pipe wall can be prevented which in the case of tobaccos having a high proportion of sap is particularly advantageous in order to prevent deposition of sap constituents. The process medium fed through the transport pipe wall may have a different composition relative to the main stream of process gas (air, superheated steam or a mixture of these constituents), by adding fresh air or steam for example. By this means it is possible to control the temperature of the product and the drying rate in the course of drying and as a result the properties of the product. In addition, control of the composition of the process air can be provided in the course of the drying process in order to allow adaptation of the product temperature to the particular drying requirements.

It is also conceivable to pass medium in the form of heating or cooling medium through the transport pipe wall without introducing it into the interior of the transport pipe. In this case, the medium may also be liquid for example.

### BRIEF DESCRIPTION OF THE DRAWINGS

Other advantageous characteristics emerge from the subsidiary claims and the following description of advantageous exemplified embodiments with reference to the attached drawings. These show:

FIG. 1: a schematic longitudinal section through a pneumatic dryer in the region of the tobacco inlet;

FIG. 2A cross-sections through the transport pipe in the region of the tobacco inlet to 2C: showing different arrangements of the dividing means;

FIG. 3 cross-sections through other embodiments of the transport pipe in the region of and 4: the tobacco inlet; and

FIG. 5: a schematic longitudinal section through another embodiment of a pneumatic dryer in the region of the tobacco inlet.

### DETAILED DESCRIPTION OF THE INVENTION

A pneumatic dryer 10 comprises a transport pipe 11 for transporting a tobacco product 23 by means of a stream 25 of process gas. The stream of process gas 25 having a temperature, for example, in the range of 110 to 450° C. is produced by means of a fan which is not shown and is conveyed through the transport pipe 11 in the direction of the arrow. In a feed section 12 of the transport pipe 11 a feed opening 13 is provided in the perimeter wall of the transport pipe 11 through which the tobacco product 23 is fed into the transport pipe 11 and transported through the transport pipe 11 by means of the stream of process gas 25. Adjoining the feed section 12 a curved section of pipe 17 can follow which passes over into the vertically arranged drying section 18. Such a pneumatic dryer reproduced here only in outline is disclosed in DE 100 46 123 A1 for example. The feed apparatus 14 connected to the feed opening 13 may comprise a rotary vane sluice 15 and a Winnover roller 16. Such a feed apparatus 14 is described in EP 0 895 721 B1.

Arranged in the feed section 12 of the feed pipe 11 is a dividing wall 19 which divides the transport pipe 11 into a product conveying part 20 and a product-free part 21. The product conveying part 20 in the transport pipe 11 is arranged in the half of the of the transport pipe 11 assigned to the feed opening 13, and the product-free part 21 in the half opposite to the feed opening 13. The end 22 of the dividing wall 19 located upstream is located in the transport direction ahead of the feed opening 13 for the tobacco product. By this means it is achieved that the tobacco product 23 is introduced substantially completely into the product conveying part 20 in the transport pipe 11, while the product-free part 21 in the transport pipe 11 remains substantially free of tobacco product 23. The dividing wall 19 extends over the curved section 17 of the transport pipe 11 into the drying section 18.

The tobacco product entering through the feed opening 13 encounters the dividing wall 19 and is conveyed along the latter by the stream of process gas 25 to the drying section 18. Accordingly, the dividing device 19 can also be referred to as a guiding device. Due to the dividing wall 19 the tobacco product 23 is introduced into the drying section 18 in a central region 26 of the transport pipe 11.

In the region of the feed opening 13 the dividing wall 19 is arranged preferably substantially perpendicular to the feed direction 24. The downstream end 27 of the dividing wall 19 is arranged in the transport direction behind the feed opening 13 for the tobacco product. Accordingly, at the downstream end 27 of the dividing wall 19 the tobacco product 23 is screened off from the opposite side 28 of the transport pipe wall by the peripherally introduced product-free stream of process gas. In this case, the opposite side 28 designates the part of the transport pipe wall located opposite the feed opening 13. Due to the screening off of the opposite side 28 of the transport pipe wall and the approximately central introduction of the tobacco product 23 into the drying section 18 a broader distribution of the tobacco product 23 in the drying section 18 and hence an improved drying result is achieved. At the tearing edge on the downstream end 27 of the dividing wall 19 turbulence occurs which can bring about the breakdown of clots of tobacco product 23 and as a result a further improvement in the results of drying. The application differs from the arrangement according to Research Disclosure No. 434, June 2000, p. 968 (see above), where the individual sub-conduits are arranged beside one another with reference to the feed opening for the tobacco product, i.e. in a plane perpendicular to the feed direction in order to allow direct feed of tobacco into all of the sub-conduits.

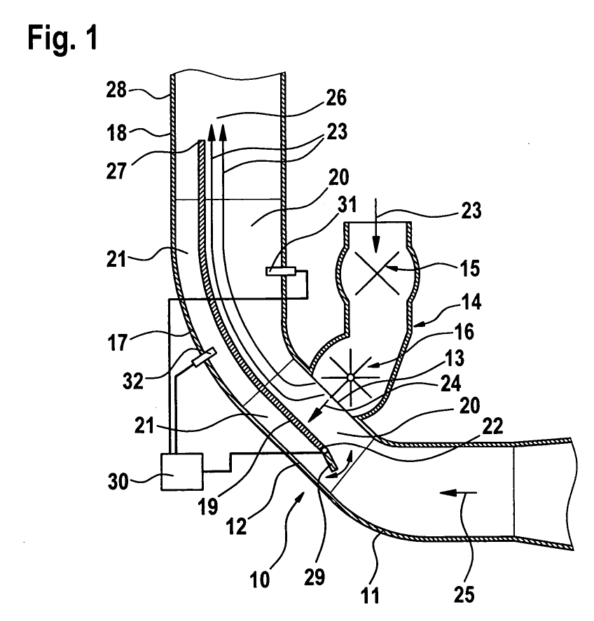

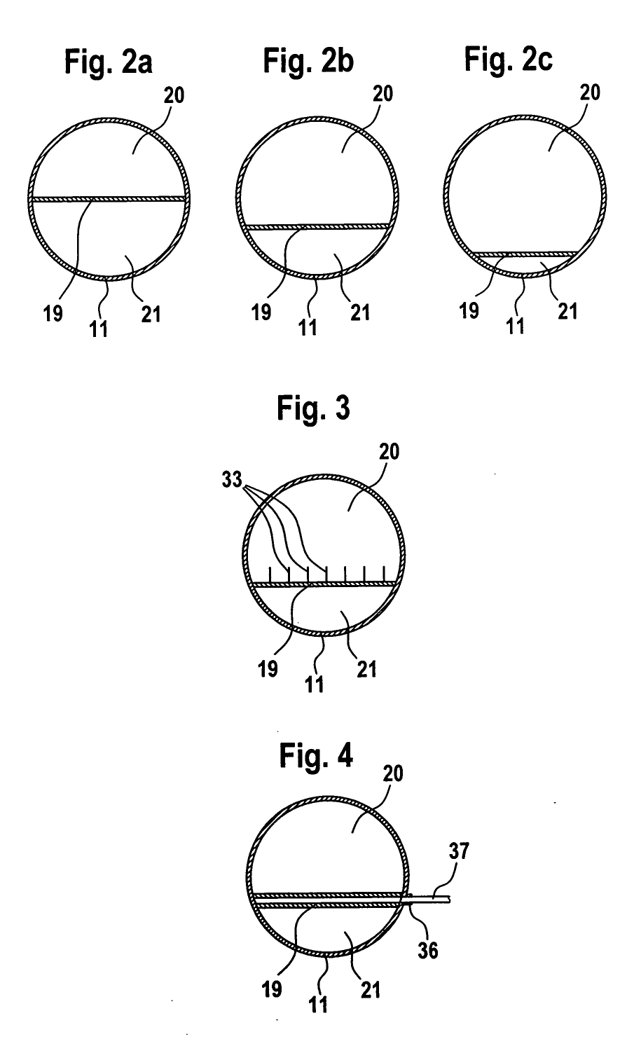

The dividing wall 19 can be arranged approximately in the region of the maximum flow rate of the free transport pipe 11, i.e. in the transport pipe 11 without the dividing wall 19. This is the case in the present exemplified embodiment (FIGS. 1, 2B and 3) where the dividing wall 19 is arranged spaced approximately 1/3 of the diameter of the transport pipe away from the transport pipe wall in the half of the transport pipe opposite the feed opening 13. FIG. 2A (dividing wall spaced approximately 50% of the transport pipe diameter away from the transport pipe wall) and FIG. 2C (dividing wall spaced approximately 15% of the transport pipe diameter away from the transport pipe wall), however, show that this is by no means necessarily the case.

The dividing wall 19 preferably divides the product conveying part 20 and the product-free part 21 completely from one another so that substantially no exchange of gas takes place between these parts of the transport pipe 11. At the end 22 of the dividing wall 19 located upstream a distributor flap 29 is arranged which is pivotable in the direction of the arrow so that the ratio of the flow rates in the product conveying part 20 and the product-free part 21 in the transport pipe 11 is adjustable as a function of the pivot position. A control device 30 can be provided to control the pivot position of the distributor flap 29. Pressure sensors 31, 32 can be provided to measure and monitor the pressure in the product conveying part 20 and/or the product-free part 21 in the transport pipe 11. Furthermore, the flow rates in the parts 20, 21 of the transport pipe 11 can be regulated on the basis of the pressures measured by means of the pressure sensors 31, 32. Preferably, the flow rate in the product conveying part 20 of the transport pipe 11 is set in the range of 10 to 29 m/s at the level of the feed opening 13.

The distributor flap 29 serves for adjusting the ratio of the volume of gas flowing per unit time in the product conveying part 20 of the transport pipe 11 relative to the product-free part 21. The total volume of gas flowing through the transport pipe 11, however, remains substantially unchanged. In this way the distributor flap 29 differs from known devices for altering the entire flow cross-section (EP 0 484 899, JP 3109044 B2).

The dividing wall 19 ends at the beginning of the drying section 18 so that the entire volume of process gas including the volume of process gas flowing through the product-free part 21 of the transport pipe 11 is available for drying the product in the drying section 18. This is different from the conditioning apparatus in Research Disclosure No. 434, June 2000, p. 968 (see above) where the product-free line merges only at the end of the drying section and accordingly the product-free process gas is not available for drying the tobacco product.

In the embodiment shown in FIG. 3 guide rails 33 running in the longitudinal direction are arranged on the side of the dividing wall 19 facing towards the feed opening 13. By this means the distribution of the tobacco product 23 over the diameter of the transport pipe 11 can be fixed and the flow lines of the process gas 25 can be aligned, i.e. a transverse component of the tobacco product 23 and of the process gas 25 is prevented which contributes to a more uniform distribution of the tobacco product 23 in the drying section 18.

The dividing wall 19 is particularly advantageous for the round cross-sections of the transport pipe 11 shown in FIGS. 2 and 3 since it prevents tobacco product 23 from accumulating in the curve of the transport pipe 11 located opposite the feed opening 13 and forming solid strands there. The invention, however, is by no means restricted to round pipe cross-sections.

The invention is not limited to one product-carrying or one product-free part of the transport pipe 11, respectively.

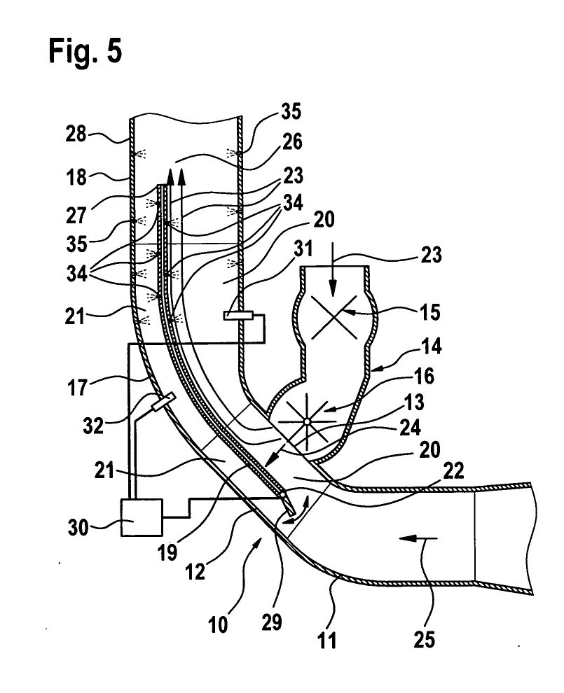

In the embodiments shown in FIGS. 4 and 5 the dividing wall 19 is of double-walled construction and comprises a connector 36 for introducing a medium through a corresponding supply line 37. A further connector which is not shown can be provided for carrying the medium away when the medium is provided only for cooling or heating the dividing wall 19. In this case, the medium may also be a liquid, for example. An outlet connector is, however, not absolutely essential when, as in the example in FIG. 5, the medium is conveyed into the interior of the transport pipe 11 through openings 34 constructed in the form of nozzles. In this case, the medium can serve in particular as fresh, hot process medium or as conditioning medium.

In the embodiment shown in FIG. 5 the perimeter wall of the transport pipe 11 is of double-walled construction. The transport pipe 11 comprises a connection, not shown, for passing medium into the wall of the transport pipe. Openings 35 are provided in the transport pipe wall for introducing fresh, hot process medium into the interior of the transport pipe 11 in order to improve the drying of the tobacco product 23. Instead of or in addition to the openings 35 a further connection which is not shown can be provided for carrying off cooling or heating medium conveyed through the transport pipe wall.

The invention has been described in detail with respect to exemplary embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

1. Apparatus for conditioning a tobacco product having a transport pipe through which a process gas flows and which has a feed section having a feed opening for feeding in the product and a following drying section, characterised in that the transport pipe has dividing means for dividing, before the feed opening, the stream of process gas into a substream picking up the product and a substream which is substantially product-free and for bringing the substreams together at the beginning of the drying section so that the product is introduced into the drying section in the inner region of the transport pipe.

2. Conditioning apparatus according to claim 1, characterised in that a part of the dividing means orientated substantially perpendicular to the feed direction extends downstream to behind the feed opening.

3. Conditioning apparatus according to claim 1, characterised in that in the case of a curved transport pipe the product-free substream is introduced into the drying section on the outer side of the curve of the transport pipe.

4. Conditioning apparatus according to claims 1, characterised in that an adjusting device is provided for adjusting the flow rate of at least one substream.

5. Conditioning apparatus according to claim 4, characterised in that the adjusting device is set in such a way that the flow rate of the substream picking up product is in the range of 10 to 29 m/s at the level of the feed opening.

6. Conditioning apparatus according to claim 4, characterised in that a control and/or regulating device is provided for controlling and/or regulating the adjusting device.

7. Conditioning apparatus according to claim 1, characterised in that at least one measuring device is provided for measuring the pressure or the flow rate of at least one substream.

8. Conditioning apparatus according to claim 4, characterised in that the control/regulating device regulates the adjusting device on the basis of the measurement signals of the at least single measuring device.

9. Conditioning apparatus according to claim 1, characterised in that the dividing means is formed by a dividing wall arranged in the transport pipe.

10. Conditioning apparatus according to claim 9, characterised in that the dividing wall is arranged substantially perpendicular to the feed direction.

11. Conditioning apparatus according to claim 9, characterised in that the dividing wall is arranged spaced from the transport pipe wall in the half of the transport pipe opposite the feed opening in the range of 10-50%, preferably 20-40%, of the transport pipe diameter.

12. Conditioning apparatus according to claim 9, characterised in that the dividing wall is arranged approximately in the region of the maximum flow rate in the open transport pipe.

13. Conditioning apparatus according to claim 9, characterised in that guide elements running in the longitudinal direction are arranged on the dividing wall for the product conveying substream.

14. Conditioning apparatus according to claim 9, characterised in that the dividing wall is constructed for conveying a medium through the interior of the dividing wall.

15. Conditioning apparatus according to claim 14, characterised in that the dividing wall has openings for conveying the medium into the interior of the transport pipe.

16. Conditioning apparatus according to claim 1, characterised in that the transport pipe is equipped for conveying a medium through the interior of the transport pipe wall.

17. Conditioning apparatus according to claim 16, characterised in that the transport pipe wall possesses openings for conveying the medium into the interior of the transport pipe.

18. Conditioning apparatus according to claim 16, characterised in that the medium conveyed through the transport pipe wall has a temperature in the range of 300 to 800° C.
